(19) United States
(12) Patent Application Publication
(10) Pub. No.: US 2016/0071121 A1
(43) Pub. Date: Mar. 10, 2016

(54) COMPUTER-IMPLEMENTED METHOD, SYSTEM, AND DEVICE FOR PROVIDING AND ANALYZING FEEDBACK AND REVIEWS

(71) Applicant: Thankz, LLC, Los Angeles, CA (US)

(72) Inventors: Leo Gestetner, Los Angeles, CA (US); Paul Wylde, Poulsbo, WA (US)

(21) Appl. No.: 14/847,352

(22) Filed: Sep. 8, 2015

Related U.S. Application Data
(60) Provisional application No. 62/048,175, filed on Sep. 9, 2014.

(51) Int. Cl. G06Q 30/02; H04W 8/00; H04W 4/02; H04W 4/00; H04W 76/02

(52) U.S. Cl. CPC G06Q 30/0201; H04W 4/008; H04W 76/023; G06Q 30/0203; H04W 4/02; H04W 8/005

(57) ABSTRACT

A computer-implemented method, system, and device for providing and analyzing feedback and reviews. The system may comprise: a feedback application and a wireless badge. The feedback application may run on a computing device, such that a feedback application enabled mobile computing device is provided. The wireless badge, which may be associated with a recipient, may transmit via a transceiver advertising packets. The feedback application enabled mobile computing device may transmit request packets to the wireless badge in response to receiving the advertising packets. The wireless badges may transmit response packets in response to receiving the request packets. After the feedback application enabled mobile computing device receives the response packet, a user may input a feedback review of the recipient. Preferably, the feedback application enabled mobile computing device and the wireless badge may wirelessly communicate with each other via a low power point-to-point communication protocol.

### CROSS-REFERENCE TO RELATED APPLICATIONS

This U.S. Non-Provisional Patent Application claims the benefit of U.S. Provisional Patent Application No. 62/048,175, filed on Sep. 9, 2014, titled “Computer-Based Method and System for Customer Feedback”, by co-inventors Leo Gestetner and Paul Wylde, the contents of which are expressly incorporated herein by this reference as though set forth in their entirety.

### FIELD OF USE

The present disclosure relates generally to software applications and wireless devices for feedback and reviews, and more specifically, to computer-based systems and wireless devices for providing feedback and reviews for recipients such as staff members and coworkers.

### BACKGROUND

Receiving intelligent and insightful customer feedback and reviews is generally an invaluable tool for business owners and consumers. In general, customer reviews help business owners make modifications, refinements, and improvements to their company or organization and help maximize customer satisfaction, employee engagement, employee retention, and the overall brand experience. This, in turn, also typically helps in increase profits, as more customers and consumers revisit that company due to consumer satisfaction. Feedback and reviews also benefit consumers, as ratings systems generally assist other consumers in making better-informed purchases.

One of the most commonly used mediums for customer reviews is an online website that provides reviews of various businesses and products. These websites are generally configured to allow customers to input feedback for a particular product or service. For example, after a review is provided by the consumer for a particular product, other potential customers may visit the website to gain a deeper understanding of the particular products and services.

Solely using websites for customer feedback, however, generally has significant limitations. Review websites, for example, generally provide consumer feedback for only particular items sold or for the business as a whole. Importantly, these websites do not provide an option for reviewing individual staff members or coworkers. As a result, business owners are unable to distinguish noteworthy and superior employee performance among individual staff members. This can lead to a poor customer experience and lower consumer satisfaction, especially in the service industry.

Another significant limitation for current models for consumer feedback is the need for customers to revisit a particular website in order to provide a customer-based review. This is generally cumbersome and time-consuming to the customer, as the customer will need to visit a website, login to that particular website, select a particular good or service, answer one or more survey questions about that particular service or product, and/or create a customer review. As a result, many consumers may be discouraged to provide his or her review.

Utilizing a review website to collect consumer feedback may also result in delayed responses due to the lack of immediate access to a computer. Many websites are neither fully optimized nor friendly for use on mobile computing devices such as smartphones. Thus, many consumers may find it difficult to leave feedback or reviews into a website using a mobile computing device. Additionally, not all consumers possessing mobile computing devices have an active data connection capable of accessing the Internet, especially when those consumers are not within proximity of a wireless Internet connection. Furthermore, even the additional step of accessing a computer to provide a consumer review may also detract consumers from leaving a review because many consumers believe that it may be too cumbersome or may simply forget to provide feedback even after obtaining access to the Internet.

Therefore, based on the foregoing, there is a need for a device, system, and/or method in which users such as customers or coworkers can provide feedback and reviews in a simple, efficient, and most importantly, rewarding manner. The device, system, and/or method for providing and analyzing feedback and reviews may focus on providing feedback on an individual employee rather than a company or its products.

### SUMMARY OF EMBODIMENTS

To minimize the limitations in the prior art, the present specification discloses a new and useful device, system, and computer-implemented method for providing and analyzing feedback and reviews.

One embodiment may be a system for providing and analyzing feedback and reviews, comprising: a feedback application; and one or more wireless badges; wherein the feedback application may be configured to run on a processor of one or more mobile computing devices, such that one or more feedback application enabled mobile computing devices are provided; wherein the one or more wireless badges may comprise a transceiver; wherein the transceiver of the one or more wireless badges may transmit one or more advertising packets; wherein the one or more wireless badges may be associated with one or more recipients; wherein the one or more feedback application enabled mobile computing devices may scan for and locates the one or more wireless badges associated with the one or more recipients located proximately near the one or more feedback application enabled mobile computing devices based on the one or more advertising packets; wherein the one or more feedback application enabled mobile computing devices may transmit one or more request packets to the transceiver of the one or more located wireless badges in response to receiving the one or more advertising packets; wherein the one or more located wireless badges may transmit one or more response packets in response to receiving the one or more request packets; wherein the one or more feedback application enabled mobile computing devices may receive one or more response packets from the one or more wireless badges; wherein the feedback application may prompt a user to input one or more feedback reviews of the one or more recipients; and wherein the one or more feedback application enabled mobile computing devices may transmit the one or more feedback reviews. The one or more advertising packets may be associated with a user identification code. The one or more response packets may be associated with a company identification code and a services identification code. The user identification code, company identification code, and services identification code of the one or more wireless badges may be configurable based on varying levels of one or more administrator privileges. The one or more feedback application enabled mobile computing devices and the one or more wireless badges may be configured to wirelessly communicate via a low power point-to-point communication protocol. The one or more feedback application enabled mobile computing devices and the one or more wireless badges may communicate with each other via the low power point-to-point communication protocol when the one or more wireless badges and the one or more feedback application enabled mobile computing devices are within an outer range of between approximately thirty to sixty feet of each other. The one or more feedback reviews may comprise: one or more user reviews associated with the one or more recipients. The one or more feedback reviews may comprise one or more attributes associated with the one or more recipients. The one or more feedback application enabled mobile computing devices may be configured to transmit the one or more feedback reviews to one or more servers. The one or more servers may be configured to display the one or more feedback reviews in a web-based environment.

Another embodiment may be a computer-implemented method for providing and analyzing feedback and reviews, the steps comprising: providing and equipping one or more wireless badges; wherein the one or more wireless badges may be associated with one or more recipients; wherein the one or more wireless badges may comprise a transceiver; transmitting one or more advertising packets by the transceiver; wherein one or more feedback application enabled mobile computing devices may be configured to scan for and locate the one or more transmitted advertising packets of the one or more wireless badges; wherein the one or more feedback application enabled mobile computing devices may be one or more mobile computing devices comprising a feedback application running on a processor of the one or more mobile computing device; wherein the one or more feedback application enabled mobile computing devices may be configured to transmit one or more request packets in response to receiving the one or more advertising packets; receiving by the one or more located wireless badges the one or more request packets from the one or more feedback application enabled mobile computing devices; transmitting by the one or more wireless badges one or more response packets based on the one or more request packets; wherein the feedback application may be configured to prompt a user to input one or more feedback reviews of the one or more recipients associated with the one or more wireless badges after the one or more feedback application enabled mobile computing devices receive the one or more response packets; and wherein the one or more feedback application enabled mobile computing devices may be configured to transmit the one or more feedback reviews. The one or more advertising packets may be associated with a user identification code. The one or more response packets may be associated with a company identification code and a services identification code. The user identification code, company identification code, and services identification code of the wireless badge may be configurable based on varying levels of one or more administrator privileges. The one or more feedback application enabled mobile computing devices and the one or more wireless badges may communicate with each other via a low power point-to-point communication protocol within an outer range of between approximately thirty to sixty feet of each other.

Another embodiment may be a wireless badge associated with a recipient having a user identification code, comprising: a processor; a transceiver; and a power source; wherein the transceiver may be electrically coupled to the processor; wherein the power source may supply power to the processor and the transceiver; wherein the transceiver may be configured to transmit one or more advertising packets to one or more mobile computing devices via a low power point-to-point communication protocol; wherein the transceiver may be configured to receive one or more request packets from the one or more mobile computing devices; wherein the one or more request packets may be sent in response to the one or more advertising packets; and wherein, in response to the one or more request packets, the transceiver may transmit the one or more response packets to the one or more mobile computing devices. The one or more advertising packets may be associated with a user identification code. The one or more response packets may be associated with a company identification code and a services identification code. The wireless badge may further comprise a light source; wherein the light source may be configured to emit at least one light signal when the transceiver receives the one or more request packets from the one or more mobile computing devices. The wireless badge may further comprise a vibrating mechanism; wherein the vibrating mechanism may be configured to vibrate the wireless badge when the transceiver receives the one or more request packets from the one or more mobile computing devices.

It is an object to provide a system, device, and computer-implemented method for providing and analyzing feedback and reviews. Preferably, the system, device, and method may comprise a feedback application configured to run on a mobile computing device and at least one wireless badge, comprising a transceiver. The feedback application may locate one or more recipients, such as employees, staff members, coworkers, and service providers located proximately near the mobile computing device. After determining that a recipient is proximately near the mobile computing device, the feedback application may prompt a user to input one or more feedback reviews (e.g., user review, attributes) for the recipient. The recipient may be, without limitation, an employee, staff member, coworker, or service provider associated with the wireless badge.

It is an object to provide a system, device, and computer-implemented method to reward, recognize, and remember service excellence. Preferably, the computer-implemented method is an alternative mechanism that allows customers, consumers, and coworkers to provide customer service feedback without performing surveys and feedback requests on an online website.

It is an object to provide a system, device, and computer-implemented method to reward and recognize a service provider, employee, or coworker in an immediate, direct, intimate, and pleasant manner.

It is an object to provide a system, device, and computer-implemented method that provides: peer recognition and praise to increase job satisfaction. Preferably, the system, device, and computer-implemented method will increase team performance and friendly competition.

It is an object to provide a system, device, and computer-implemented method that tracks and measures feedback and reviews without managing and tracking the service providers or recipients.

It is an object to provide a system, device, and computer-implemented method that increases productivity among service providers and employees while increasing self-value awareness.

It is an object to provide a system, device, and computer-implemented method that tracks employee engagement without intimidation or interference.

It is an object to provide a system, device, and computer-implemented method that captures key performance indicators for individual growth, department successes, and division performance.

It is an object to overcome the deficiencies of the prior art.

These, as well as other components, steps, features, objects, benefits, and advantages, will now become clear from a review of the following detailed description of illustrative embodiments, of the accompanying drawings, and of the claims.

### BRIEF DESCRIPTION OF THE DRAWINGS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is an illustration of one embodiment of a system and computer-implemented method for providing and analyzing feedback and reviews.

FIG. 2 is a block diagram of one embodiment of a computing device.

FIG. 3 is a block diagram of one embodiment of a wireless badge.

FIG. 4 is a flow diagram of one embodiment of a system for providing and analyzing feedback and reviews.

FIG. 5 is a table of one embodiment of a packet data unit for an advertising packet.

FIG. 6 is a table of one embodiment of a packet data unit for a response packet.

FIG. 7 is a table of another embodiment of a packet data unit for a response packet.

FIG. 8 is an illustration of one embodiment of the scanning activity between the wireless badge and computing device.

FIG. 9 is a data table for one embodiment of a data table residing on the server

FIG. 10 is a state diagram of one embodiment of the system for providing and analyzing feedback and reviews.

FIG. 11 is an illustration of one embodiment of the mobile computing device with the feedback application and shows the results of the scanning function of the feedback application.

FIG. 12 is an illustration of another embodiment of the mobile computing device with the feedback application and shows the results of the scanning function of the feedback application.

FIG. 13 is one embodiment of the mobile computing device with the feedback application and shows how a user can select an attribute for a recipient with the feedback application.

FIG. 14 is one embodiment of the mobile computing device with the feedback application and shows how a user can create and upload a user review to a server and social media.

FIG. 15 is an illustration of one embodiment of an email, showing how a user may utilize the feedback application via a hyperlink in a received email.

FIG. 16 is a screenshot of one embodiment of the recipient profile as shown in the feedback application.

FIG. 17 is a screenshot of one embodiment of the server, and shows the data and analytics of the feedback application.

FIG. 18 is another screenshot of one embodiment of the server, and shows data and analytics of the feedback application.

### DETAILED DESCRIPTION OF THE DRAWINGS

In the following detailed description, numerous specific details are set forth in order to provide a thorough understanding of various aspects of one or more embodiments. However, the one or more embodiments may be practiced without some or all of these specific details. In other instances, well-known procedures and/or components have not been described in detail so as not to unnecessarily obscure aspects of the embodiments.

While some embodiments are disclosed herein, still other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For example, as used herein, the terms “computer”, “computing device”, or “computer system” refer to any device or machine that processes data or information with an integrated circuit chip, including without limitation, personal computers, mainframe computers, workstations, testing equipment, servers, desktop computers, portable computers, laptop computers, embedded computers, wireless devices including cellular phones, personal digital assistants, tablets, tablet computers, smartphones, portable game players, and hand-held computers. Computing devices may also include mobile computing devices such as smartphones, tablets, wearables, and the like. The mobile computing device may also be a feedback application enabled mobile computing device, which is preferably a mobile computing device configured with a feedback application running by a processor of the mobile computing device.

The terms “application”, “software”, “software application”, or “feedback application” generally refer to any set of machine-readable instructions on a client machine, web interface, and/or computer system, that directs a computer's processor to perform specific steps, processes, or operations disclosed herein. The “application”, “software”, “software application”, and “feedback application” may comprise one or more modules that direct the operation of the computing device or computer system on how to perform the method for providing and analyzing feedback and reviews. For purposes of this specification, a module may be implemented as a hardware circuit comprising custom VLSI circuits or gate arrays, off-the-shelf semiconductors such as logic chips, transistors, or other discrete components. A module may also be implemented in programmable hardware devices such as field programmable arrays, programmable array logic, programmable logic devices, and the like. Modules may also be implemented in software for execution by various types of processors. An identified module of executable code may, for instance, comprise one or more physical or logical blocks of computer instructions, which may, for instance, be organized as an object procedure, or function. Nevertheless, the executables of an identified module need not be physically located together, but may comprise disparate instructions stored in different locations, which when joined logically together, may comprise the module and achieve the stated purpose for the module.

As used herein, the term “interface device” refers to a mouse, touchpad, touchscreen, joystick, trackball, keyboard, and the like.

As used herein, the term “computer-readable medium” refers to any device or component used to store data or information. Examples of such include, without limitation, a computer-readable medium device such as floppy disk, magnetic hard disk drive, universal serial bus (USB) thumb drive, and solid state hard disk, memory such as flash memory, random access memory (RAM), memory, read-only memory (ROM), optical disk, magneto-optical disk, and register files of a processor.

As used herein, the terms “badge” and “wireless badge” generally refer to any device or apparatus that may be worn, fastened, secured, attached to, placed on, and/or proximately associated with a recipient such as an individual, location, or thing in order to receive feedback or a review for that recipient. For example, the badge or wireless badge may be worn by an individual as a wearable (e.g., pin, lapel pin, cufflink, wristband, belt, belt accessory, watch, clip on, ring, bracelet, hat, shirt). The badge or wireless badge may also be associated with a company or business establishment such as hotel, restaurant, or service provider by placing the wireless badge proximately near to or within the location or establishment. For instance, the badge or wireless badge may be placed on a reception desk of a hotel; at a point of sale checkout terminal for a store; or affixed on the wall of the hotel or restaurant. Similarly, the badge or wireless badge may also be associated with a thing or object. The wireless badge may be attached to the object or may be placed proximately near to the object.

As used herein, the term “recipient” refers to any individual, company, location, and/or thing or object that is the intended receive a feedback or review via the wireless badge. Thus, the recipient may be a person or individual such as an employee, staff member, coworker, volunteer, or service provider. The recipient may also be a company (e.g., hotel, restaurant, service provider) or location (e.g., point of sale, reception desk, self-service checkout). Finally, the recipient may also refer to a thing or object (e.g., airplane, desk, airport terminal, sample display product).

As used herein, the terms “service provider”, “staff”, “staff member”, and “employee” refer to a person or individual who works for an employer (e.g., another person, company, firm, organization) for wages or salary. The employee or service provider is an agent of the employer to the extent that the employee or service provider is authorized to act for the employer. The employer generally controls, or has a right to control, the time, place, and method of doing work and is responsible for the actions of employee or service provider performed within the course of his or her employment. The term “service provider” may also include individuals who works for an employer without wages or salary such as volunteers.

As used herein, the term “proximately near” refers to the distance in which the badge or wireless badge may connect wirelessly or interact with the mobile computing device based on the type of wireless technology or protocol. For instance, in one embodiment, the wireless badge may connect wirelessly or interact with the mobile computing device via Bluetooth® by placing the wireless badge within an outer range of between approximately thirty to sixty feet of the mobile computing device. In another embodiment, the wireless badge may connect wirelessly or interact with the mobile computing device via iBeacon® technology by placing the wireless badge within approximately one meter from the mobile computing device. In another embodiment, the wireless badge may connect wirelessly or interact with the mobile computing device via near field communication (NFC) protocol by placing the wireless badge within approximately 10 centimeters from the mobile computing device. Thus, the actual distance when placing the wireless badge “proximately near” the mobile computing device generally depends upon the type of wireless technology implemented.

As used herein, the terms “prompt” or “prompting” may refer to any act by the feedback application to assist or encourage a user to perform a certain act. The terms “prompt” or “prompting” may also refer to any passive action or inaction by the feedback application that allows or permits a user to perform a certain act without the assistance or act of the feedback application.

As used herein, the terms “approximately” and “about” generally refer to a deviance of within 5% of the indicated number or range of numbers. In one embodiment, the term “approximately” and “about”, may refer to a deviance of between 1-10% from the indicated number or range of numbers.

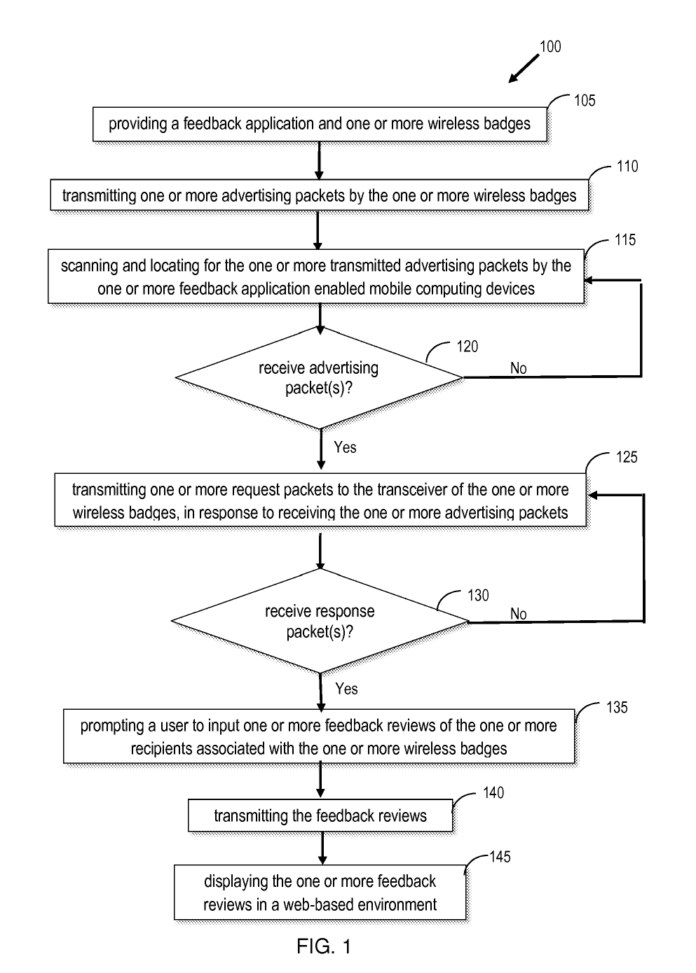

FIG. 1 is an illustration of one embodiment of a system and computer-implemented method for providing and analyzing feedback and reviews. As shown in FIG. 1, one embodiment of the computer-implemented method 100 may comprise steps 105, 110, 115, 120, 125, 130, 135, 140, 145. Specifically, FIG. 1 shows that the method 100 may comprise the first step 105 of providing a feedback application and one or more wireless badges. The feedback application and system may comprise an application or software program that runs on a mobile computing device and is preferably configured to wirelessly connect and interact wirelessly with the wireless badges. The feedback application may be configured to allow the user, customer, consumer, or coworker to connect wirelessly to a badge that is worn by a recipient such as a service provider, employee, or colleague and provide feedback and recognition to a particular recipient wearing that wireless badge. This will preferably allow the customer or consumer to help recognize, reward, and/or inspire the employee or individual for his or her services.

In one embodiment, the feedback application and system may allow a user, consumer, or coworker to input one or more feedback reviews based on his or her experience. This will preferably allow the user to provide an evaluation of a recipient's performance. The feedback review generally encourages staff morale as well as improve individual and team performance. Feedback reviews may also aid in the shopping decision of a prospective consumer. In various embodiments, the feedback review may be in the form of a user review, which is generally in the form of several lines of texts and may be accompanied by a numerical rating. The feedback reviews may also comprise assigning one or more attributes to a particular recipient. Examples of some attributes may include, without limitation, helpful, attentive, effective, witty, inspiring, and quick. The user review may comment or assign attributes, indicating how well the employee measures up to expectations and may evaluate performance, service experienced, and dependability or trustworthiness of the employee.

The feedback application and system may also comprise varying levels of administrative privileges. In one embodiment, the feedback application and system may comprise a user-level application, which allows general consumers to rate their experiences with various employees. In another embodiment, the feedback application may also comprise an application with administrative privileges, in which an administrator may be able to configure each wireless badge and/or feedback application. For example, the administrator may be able to set or change the company, employee, and/or services information within each wireless badge device. The administrator may also be able to configure the company, employee, and/or services information stored in the server.

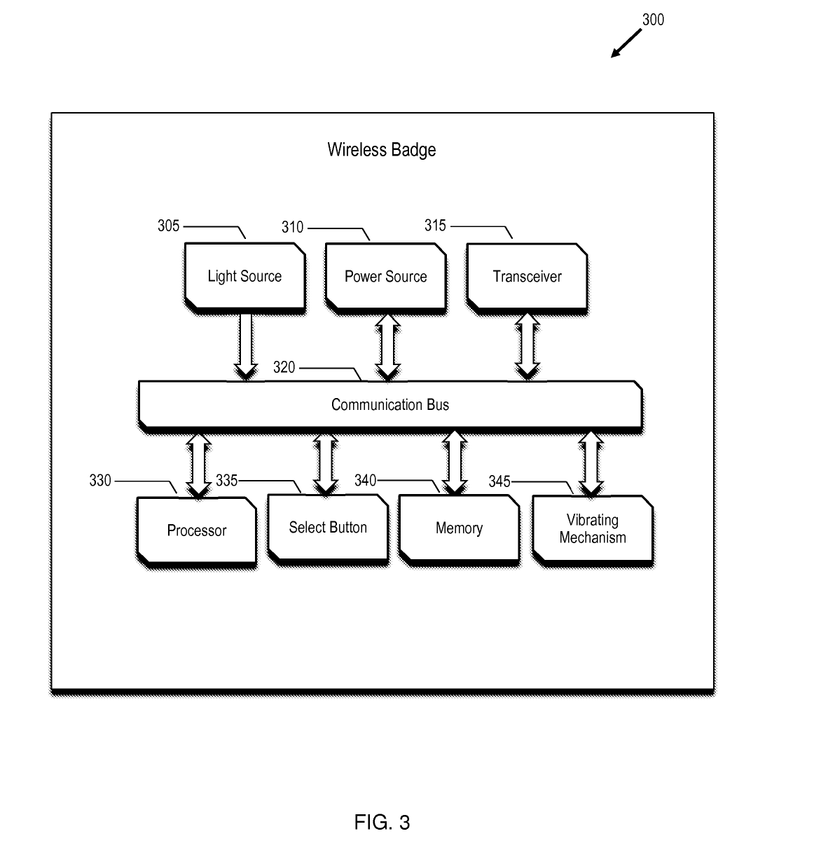

The wireless badge (shown in FIG. 3) is preferably an electronic device that wirelessly communicates with the mobile computing devices. In one embodiment, the wireless badge may communicate with the mobile computing device via low power point-to-point communication protocol such as Bluetooth®. In other embodiments, the wireless badge may also communicate with the mobile computing device with other various protocols and technologies such as WiFi®, WiMax®, iBeacon®, near field communication (NFC), and Miracast®. This may depend upon the distance between the wireless badge and mobile computing device. For example, in one embodiment, the wireless badge may connect with the mobile computing device via Bluetooth® by placing the wireless badge within an outer range of between approximately thirty to sixty feet of the mobile computing device. In another embodiment, the wireless badge may connect wirelessly with the mobile computing device via iBeacon® technology by placing the wireless badge within approximately one meter from the mobile computing device. In another embodiment, the wireless badge may connect wirelessly with the mobile computing device via near field communication (NFC) protocol by placing the wireless badge within approximately 10 centimeters from the mobile computing device. In a preferred embodiment, the wireless badge may wirelessly communicate with the mobile computing devices within at least sixty feet.

The wireless badge is generally worn by the recipient such as an employee or individual, so that the wireless badge may be associated with that recipient. The wireless badge may also be associated with a location, place, or thing. In one embodiment, the wireless badge may comprise a transceiver as a single component for transmitting and receiving wireless signals. In an alternative embodiment, the wireless badge may comprise a transmitter and receiver as separate components. Preferably, the transceiver or transmitter is configured to emit various wireless signals in order to be discoverable and to exchange data with nearby mobile computing devices. For example, in one embodiment, the wireless badge may emit one or more advertising packets in order to be discoverable by a nearby mobile computing device.

In various embodiments, the wireless badge may comprise additional components such as a light source and/or a vibrating mechanism. The light source may be electrically coupled to the processor and may emit a light signal when the processor or other component is performing a task. For example, in one embodiment, the light source may emit a light signal when the transceiver receives one or more request packets and/or advertising packets from the mobile computing devices. Similarly, the light source may emit a light signal when the transceiver transmits a response packet signal. Regarding the vibrating mechanism, the vibrating mechanism may also be electrically coupled to the processor and may create a vibration when the processor or other component performs a task. For example, the vibrating mechanism may cause the wireless badge to vibrate when the transceiver receives the request packets from said one or more computing devices.

FIG. 1 also shows that the method 100 may comprise a second step 110, which may be transmitting one or more advertising packets by the one or more wireless badges. As discussed above, the wireless badge may connect to a mobile computing device by a low power point-to-point communication protocol (e.g., Bluetooth®) or by other various protocols (e.g., iBeacon®, NFC, WiFi®, WiMax®, Miracast®). In particular, the wireless badge, in a preferred embodiment, may send or transmit advertising packets in order to have mobile computing devices find or connect with the wireless badge. During transmission of the advertising packets, the mobile computing device, which may be enabled by a feedback application, may then scan and locate for the transmitted advertising packets, as shown in step 115. Thus, in order to discover, pair, and/or connect to a wireless badge, the mobile computing device may first scan or search for advertising packets transmitted by the wireless badges. Upon receiving an advertising packet in step 120, the mobile computing device may respond by transmitting one or more request packets to the transceiver of the wireless badges, shown in step 125. Otherwise, the feedback application may search for additional advertising packets. In response, the wireless badge may then send one or more response packets to the mobile computing device in order to pair or wirelessly connect with the mobile computing device. The mobile computing device may then receive the response packet from the wireless badge, as shown in step 130. In the event that the mobile computing device receives the response packet(s), the mobile computing device may then connect with the services provider or employee wearing the wireless badge. Steps 110, 115, 120, 125, 130 may help determine the number of wireless badges (and employees/service providers) that are located within short proximity from the mobile computing device.

In another embodiment, the mobile computing device may respond to a direct connection request in the event that the mobile computing device knows the address of the wireless badge. In an alternative embodiment, connection between the devices may require pairing or acceptance by its users, and may be held until one of the devices is out of range. In various embodiments, multiple mobile computing devices may be connected to a single wireless badge at a time. In other various embodiments, a single mobile computing device may be connected to multiple wireless badges at the same time.

As discussed above, the method 100 may comprise step 135, which may be prompting a user to input one or more feedback reviews of the one or more recipients associated with the one or more wireless badges. After recognizing or pairing with the wireless badge of the nearby recipient, the feedback application may prompt the user to leave one or more feedback reviews of that recipient wearing the badge. The feedback reviews are generally any information regarding a product, person, or person's performance of a task used as a basis for improvement. The feedback reviews may comprise a user review, which is generally information describing an employee, service provider, or individual wearing the wireless badge and coming directly from the customer or consumer. A preferred example of a user review may be a detailed description of the recipient written or prepared by the user. In an alternative embodiment, the feedback reviews may also comprise one or more attributes, which are generally any quality or feature characterizing the employee, coworker, service provider, or service performed by the employee. Examples of attributes may include, without limitation, polite, cheerful, helpful, gentle, optimistic, compassionate, attentive, communicative, candid, and the like.

In one embodiment, the user may be a customer or consumer who is providing a feedback or review for a recipient such as an employee, staff member, or volunteer. In another embodiment, the user may be a coworker who is providing a feedback or review for a recipient such as coworker or colleague. In various embodiments, the recipient may be a place, location, business, company, or thing/object.

Once the user or customer inputs the feedback reviews into the feedback application, the user may proceed to the next step 140, which may be transmitting the feedback reviews. In one embodiment, the feedback reviews may be wirelessly transmitted to a server. In another embodiment, the feedback reviews may be transmitted to a computer-readable medium. The server may be a computer system or computer program that manages access to a centralize resource or service in a network and may function as a repository for information regarding employees associated with a particular company. The server may be wirelessly connected to the mobile computing device via the Internet or World Wide Web. The Internet may be a computer network comprising a worldwide network of computer networks that utilize the TCP/IP network protocols to facilitate data transmission and exchange. In the event that the mobile computing device has access to the Internet, the user may transmit, upload, or send his or her feedback reviews to a computer-readable storage device of a server. The feedback review may then be displayed in a web-based environment, as shown in step 145. Although FIG. 1 shows only nine steps, it should be understood that the method 100 may comprise any number of steps, and some steps may be performed at the same time or out of order.

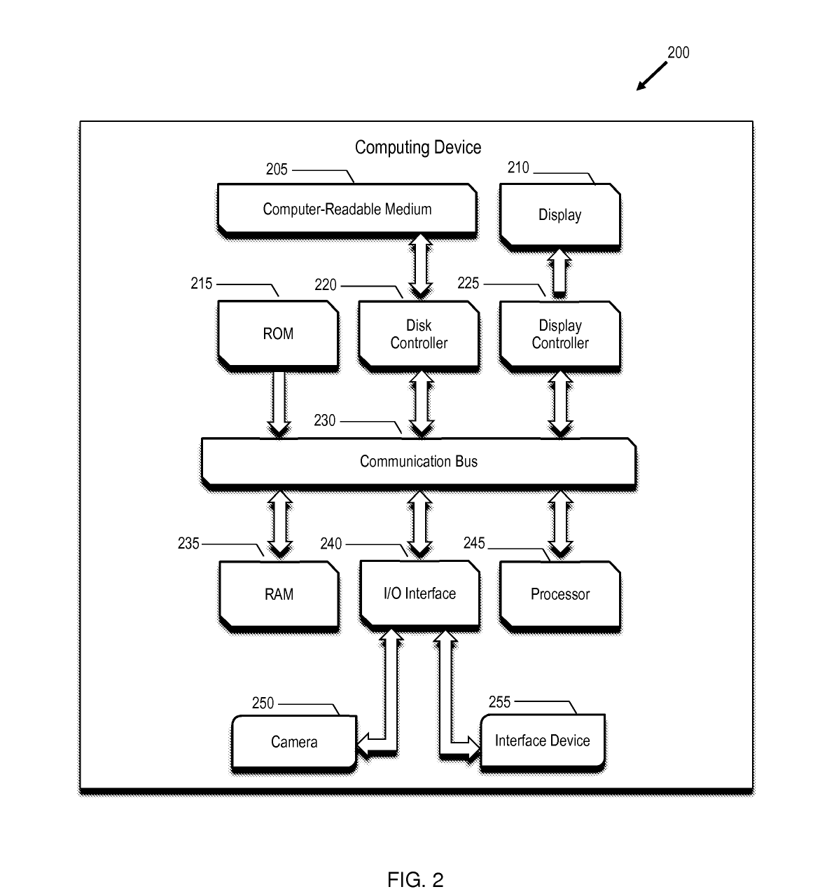

FIG. 2 is a block diagram of one embodiment of a computing device. As shown in FIG. 2, one embodiment of the computing device 200 may comprise: a computer-readable medium 205, display 210, read only memory (ROM) 215, disk controller 220, display controller 225, communication bus 230, random access memory (RAM) 235, input/output (I/O) interface 240, processor 245, camera 250, and one or more interface device 255, wherein the one or more interface devices may be: a keyboard, pointing device (e.g., mouse), and/or a touchscreen. The processor 245 is generally any component, or logic circuitry that responds to and processes the basic instructions that drive the computing device 200. The processor 245 may be electronically coupled to a communication bus 230, and the communication bus 230 may be electronically coupled to other electronic hardware or components, including without limitation, a display controller 225, RAM 235, ROM 215, disk controller 220, and I/O interface 240. The disk controller 225 may be configured to control the computer-readable medium 205, which may be a hard drive and/or optical disk drive. The computer-readable medium 205 may also be another form of random access memory or flash memory. The display controller 225 may be coupled to a display 210 such as a liquid crystal display (LCD), projection system, or touchscreen. The I/O interface 240 may be coupled to one or more input devices such as an interface device 255 (e.g., mouse, keyboard, pointing device, touchscreen) or camera 250. The camera 250 may be any component or electronic device capable of capturing one or more images and/or videos onto an electronic memory component. In additional embodiments, the computing device 200 may also comprise a network controller card that may connect to a network, such as the Internet or along an Intranet. In various embodiments, the computing device 200 may include mobile computing devices, including without limitation, laptops, smartphones, tablets, and wearables.

The processor 245 may be configured to execute a set of computer readable instructions and further to execute a software program, application or computer implemented instructions described herein such as the feedback application. The computer readable instructions and application may comprise instructions that cause the processor 245 to perform one or more processes when the instructions are executed by the processor 245. In other various embodiments, the computer readable instructions or application may be tangibly embodied in the memory of the computer system 200 such as the RAM 235 or ROM 215, as shown in FIG. 2, or on a computer-readable storage medium, such as a magnetic, optical or solid-state digital storage medium. Although FIG. 2 shows that the computing device 200 comprises eleven components, it should be understood that the computing device may comprise any number of components.

FIG. 3 is a block diagram of one embodiment of a wireless badge. As shown in FIG. 3, one embodiment of a wireless badge 300 may comprise: a light source 305, power source 310, transceiver 315, communication bus 320, processor 330, select button 335, memory 340, and vibrating mechanism 345. The light source 305 is generally any light indicator or optical transmitter serving as a source of illumination. The light source 305 may be, without limitation, various light sources such as light emitting diodes (LED), fluorescent, halogen, incandescent, and the like. The vibrating mechanism 345 is generally a component that produces a physical vibration or alert for the wireless badge 300. In one embodiment, the vibrating mechanism 345 may be a small electric motor such as vibration motor. The vibrating mechanism 345 may also be any eccentric rotating mass actuators or linear resonant actuators. The power source 305 is generally any source of electricity for a device, which converts, regulates, supplies, and/or transmits external power to the wireless badge 300. Various power sources 305 may include, without limitation, batteries, power supplies, and the like. The transceiver 315 is generally any device or component that can both transmit and receive wireless communications, and more particularly, a combined transmitter and receiver. The processor 330 is generally any component or logic circuitry that responds to and processes the basic instructions stored in the memory 340. The light source 305, power source 310, transceiver 315, processor 330, select button 335, memory 340, and vibrating mechanism 345 may be electronically coupled to each other via the communication bus 230.

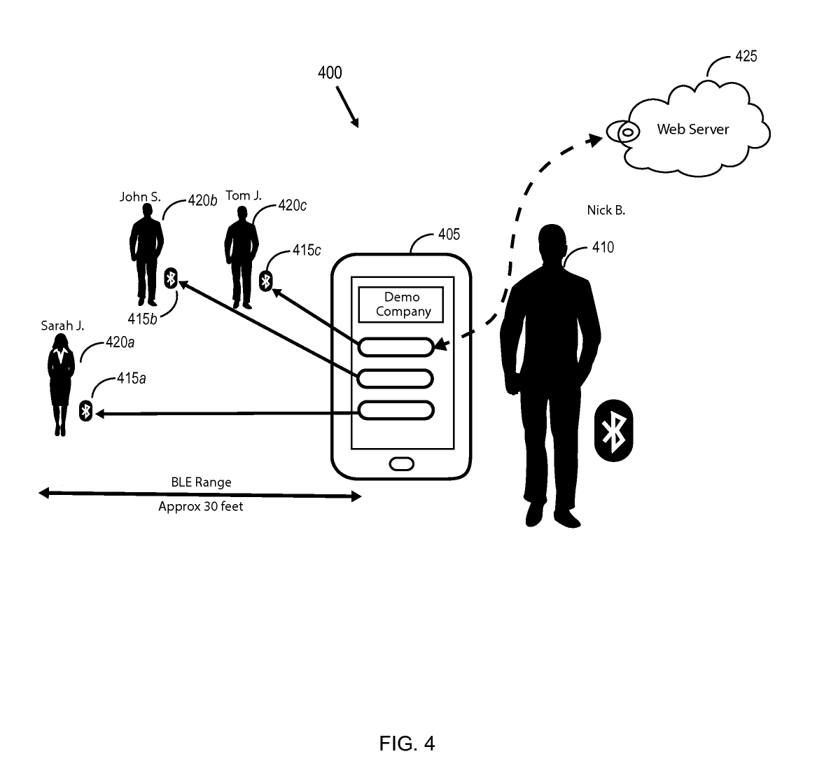

FIG. 4 is a flow diagram of one embodiment of a system for providing and analyzing feedback and reviews. As shown in FIG. 4, one embodiment of the system 400 may comprise: a mobile computing device 405, wireless badges 415a, 415b, 415c, and a server 425. FIG. 4 shows that the mobile computing device 405 may wirelessly connect with the wireless badges 415a, 410b, 410c via a low power point-to-point communication protocol such as Bluetooth®, iBeacon®, and NFC. Once paired with the wireless badges 415a, 415b, 415c, the user, coworker, or customer 410 may provide feedback reviews of recipients 420a, 420b, 420c associated with the wireless badges 415a, 415b, 415c, respectively. Customer 410 may, for instance, provide user reviews or information describing the services of the recipients 420a, 420b, 420c. Customer 410 or coworker may also assign one or more attributes to each of the recipients 420a, 420b, 420c describing each of the recipients 420a, 420b, 420c with various skillsets or characteristics in relation to his or her services. Importantly, each of the wireless badges 415a, 415b, 415c may be associated with a user identification code, which corresponds or identifies each of the recipients 420a, 420b, 420c. The wireless badges 415a, 415b, 415c may also be associated with a company identification code and services identification code in order to identify each employee's respective company and services. After receiving feedback reviews from the customer 410, the customer 410 may upload the feedback review to the server 425.

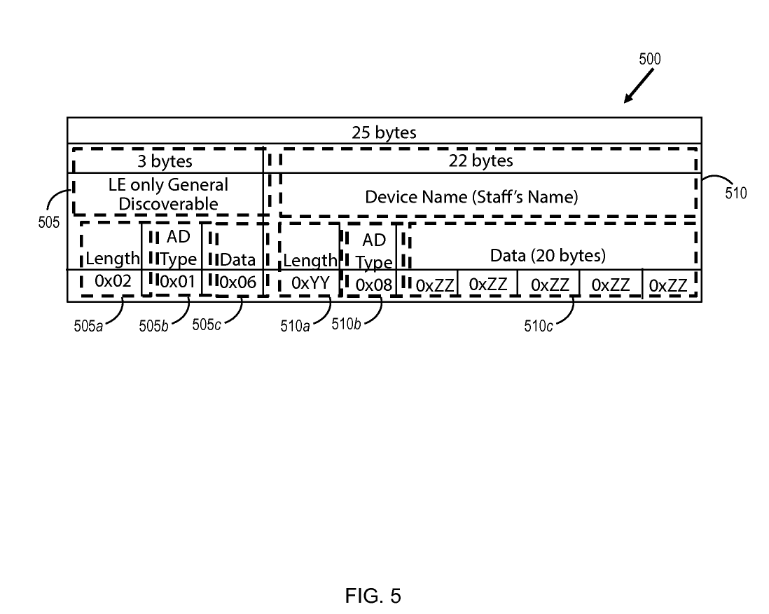

FIG. 5 is a table of one embodiment of a packet data unit for an advertising packet. As shown in FIG. 5, one embodiment of the packet data unit 500 for an advertising packet may comprise a discovery data portion 505 and device type data portion 510. The discovery data portion 505 generally provides information that the wireless badge is in discovery mode and may comprise: a length field 505a, advertising type field 505b, and a data field 505c. The length field 505a may provide information as to the length of the discovery data portion 505. The advertising type field 505b may provide information as to advertising data type formats acceptable to certain mobile computing devices, which may be various classes of universally unique identifiers (UUID) that are manufacturer specific. In one embodiment, as shown in FIG. 5, the advertising type field 505b may be 0x01, which may indicate various flags. The data type field 505c of the discovery data portion 505 may provide information as to the data itself, and, in one embodiment, the data field 505c may indicate that the wireless badge is in discoverable mode. In this embodiment, the discovery data portion 505 may be three bytes long.

The device type data portion 510 generally provides information about the device itself (which may include information as to the identification of the recipient such as the employee, service provider, or staff). FIG. 5 shows that one embodiment of the device type data portion 510 may also comprise: a length field 510a, advertising type field 510b, and a data field 510c. The length field 510a of the device type data portion 510 may provide information as to the length of the device type data portion 510. The advertising type field 510b may provide information as to advertising data type formats acceptable towards certain mobile computing devices. The data type field 510c may provide information as to the identification of the recipient such as the employee, service provider, or staff, which is generally device specific. Thus, the advertising packet may provide information as to the recipient's name and other information. In one embodiment, as shown in FIG. 5, the device type data portion 510 may be twenty-two bytes long.

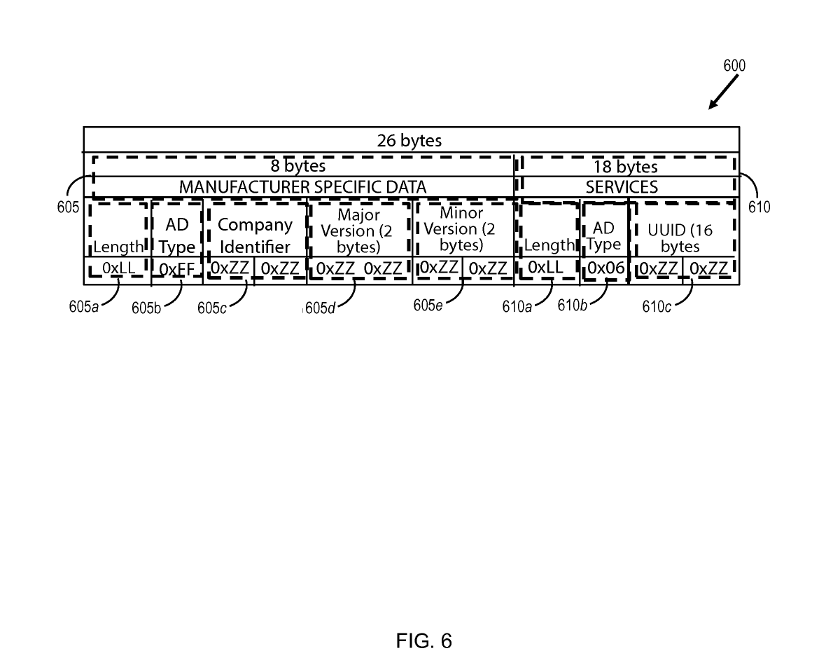

FIG. 6 is a table of one embodiment of a packet data unit for a response packet. As shown in FIG. 6, one embodiment of the packet data unit 600 for a response packet may comprise a manufacturer data portion 605 and services data portion 610. The manufacturer data portion 605 generally provides information as to the recipient and recipient's company or organization. The manufacturer data portion 605 may comprise: a length field 605a, advertising type field 605b, company identifier field 605c, major version field 605d, and minor version field 605e. The length field 605a may provide information as to the length of the manufacturer data portion 605. The advertising type field 605b may provide information as to advertising data type formats acceptable to certain mobile computing devices, which may be various classes of UUID that are manufacturer specific. The company identifier field 605c may provide information identifying the company or organization of the recipient. The major version 605d may provide additional information regarding the company. The minor version 605e may provide information as to name of the employee or recipient. In this embodiment, the manufacturer data portion 605 may be eight bytes long.

The services data portion 610 generally provides information about the services of the recipient. FIG. 6 shows that one embodiment of the services data portion 610 may also comprise: a length field 610a, advertising type field 610b, and a UUID field 610c. The length field 610a may provide information as to the length of the services data portion 610. The advertising type field 610b may provide information as to advertising data type formats. The UUID field 610c may provide information as to the identification of the services of the recipient. Thus, the response packet may provide information as to the recipient's name, company, and other information. In one embodiment, as shown in FIG. 6, the services data portion 610 may be eighteen bytes long.

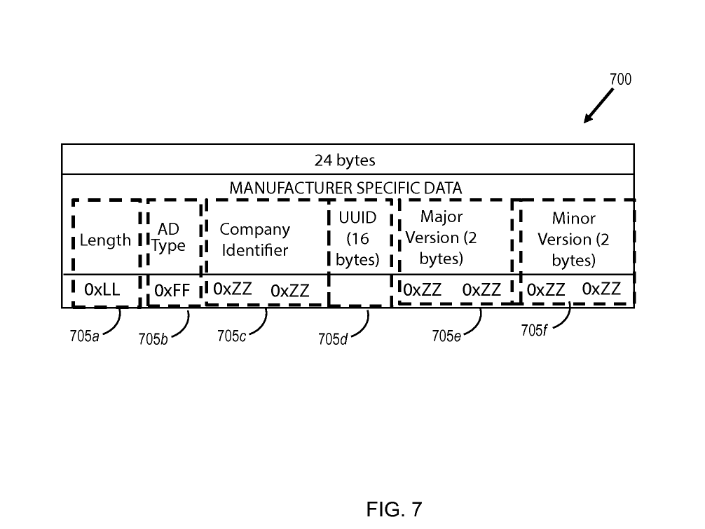

FIG. 7 is a table of another embodiment of a packet data unit for a response packet. As shown in FIG. 7, another embodiment of the packet data unit 700 for a response packet may comprise: a length field 705a, advertising type field 705b, company identifier field 705c, UUID field 705d, major version field 705e, and minor version field 705f. The length field 705a may provide information as to the length of the packet unit 700. The advertising type field 705b and UUID field 705d may provide information as to the UUID. The company identifier field 705c may provide information identifying the company or organization of the recipient. The major version 705e may provide additional information regarding the company. The minor version 705f may provide information as to name of the recipient. In this embodiment, the packet data unit 700 may be twenty four bytes long.

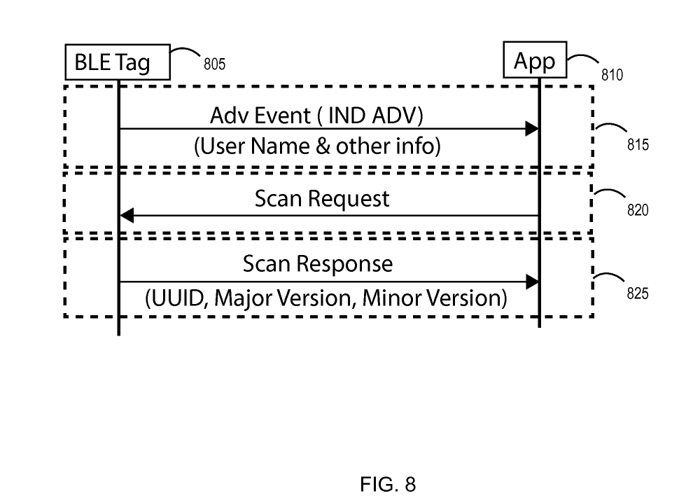

FIG. 8 is an illustration of one embodiment of the scanning activity between the wireless badge and computing device. FIG. 8 specifically shows how a wireless badge 805 may interact with a mobile computing device 810, according to one embodiment. Specifically, the wireless badge 805 may send out an advertising signal or advertising packet 815, which generally includes information as to the recipient. In response, the mobile computing device 810 may send a request packet 820 to the wireless badge 805 upon determining that the wireless badge 805 is proximately near the mobile computing device 810. Upon receiving the request packet 820, (also referred to as a scan request), the wireless badge 805 may then send a response packet 825, also referred to as a scan response), which may include UUID, major, and minor information of the service provider (e.g., company name, service provider name, services of that service provider).

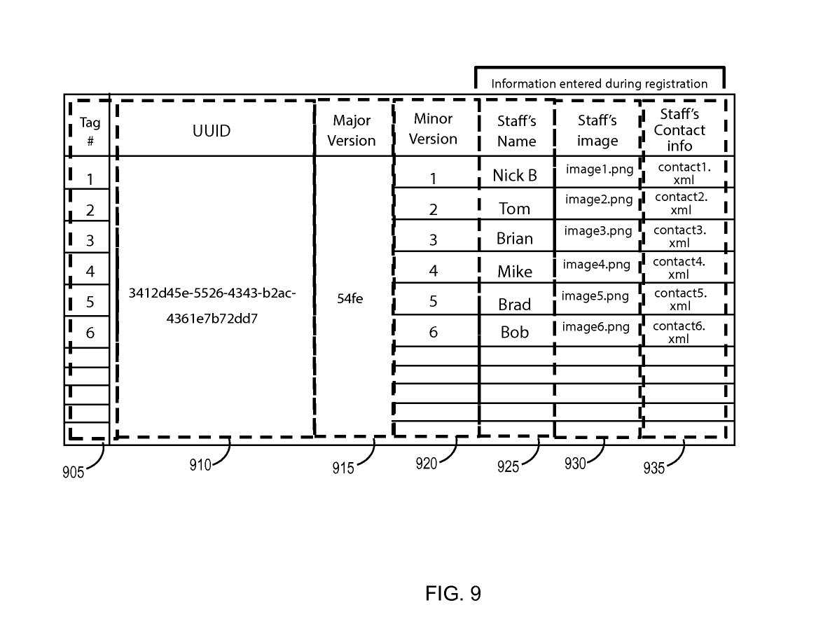

FIG. 9 is a data table for one embodiment of a data table residing on the server. As shown in FIG. 9, one embodiment of the data table 900 may comprise: tag data 905, UUID data 910, major version data 915, minor version 920, recipient name data 925, recipient image data 930, and recipient contact information data 935. The tag data 905 and UUID data 910 may be any unique identifier that is assigned to each wireless badge for uniquely identify each wireless badge. Similarly, the major version data 915 and minor version data 920 may also be any unique identifier that identifies and assigns the company and/or recipient for each wireless badge. For example, in one embodiment, the major version data 915 may be used to identify a specific organization or company, whereas the minor version data 915 may be used to identify a specific employee, service provider, or staff. The recipient name data 925 may be the actual name of the recipient. The recipient image data 930 may be any image file or data used to correspond with an image of a particular recipient. The staff contact information data 935 may be any file or information used to contact the recipient and may include a phone number, mailing address (e.g., company address, home address), and/or email address.

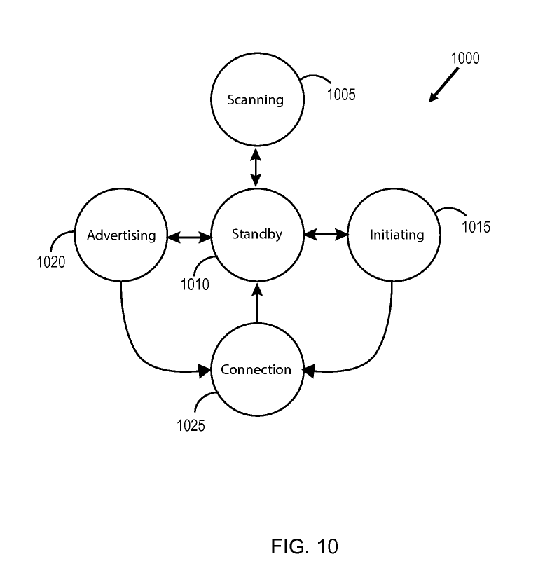

FIG. 10 is a state diagram of one embodiment of the system for providing and analyzing feedback and reviews. A shown in FIG. 10, one embodiment of the system 1000 may comprise states 1005, 1010, 1015, 1020, 1025. FIG. 10 shows the behavior of the system 1000 for providing and analyzing feedback and reviews and may represent a series of events that could occur in one or more possible states. For example, in state 1005, the system may be scanning in order to search for other wireless badges within the vicinity. After scanning for other wireless badges, the system may transition into state 1010, which allows the system to be on standby. While on standby, the system has the option to transition into state 1015 by initiating a connection between the wireless badge and the computer-implemented feedback application. Otherwise, the system may transition into state 1020 to advertise the availability of the wireless badge. If the wireless badge and computer-implemented feedback application are initiating a connection in state 1015, the system may transition into state 1025 where the user may provide one or more feedback reviews. Otherwise, if the system is in state 1020, the system may advertise and transition into standby in state 1010 or establish a connection in state 1025.

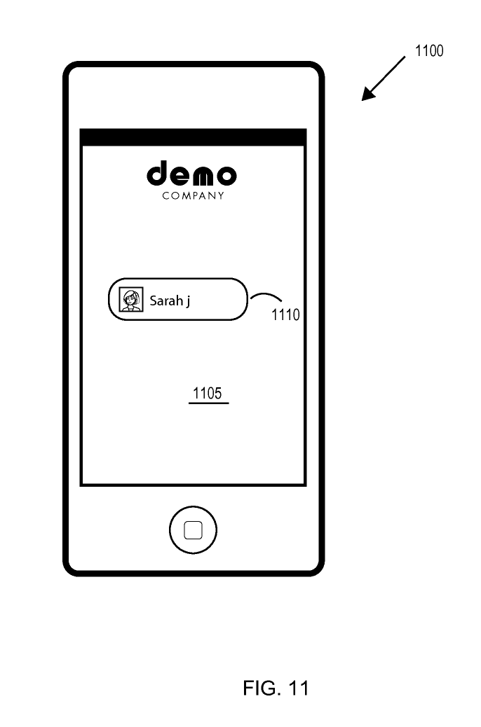

FIG. 11 is an illustration of one embodiment of the mobile computing device with the feedback application and shows the results of the scanning function of the feedback application. As shown in FIG. 11, one embodiment of the mobile computing device 1100 may comprise a feedback application 1105. FIG. 11 shows that, after the mobile computing device 1100 scans and receives a response packet from nearby wireless badges, the computer feedback application 1105 may discover a wireless badge associated with one or more recipients. For example, in one embodiment, the wireless badge may be associated with a recipient Sarah J. The feedback application 1105 may perform a scan function and identify Sarah J.'s wireless badge by showing her contact 1110 within the feedback application 1105. By selecting her contact 1110, the feedback application 1105 may then pair or connect with Sarah J.'s wireless badge.

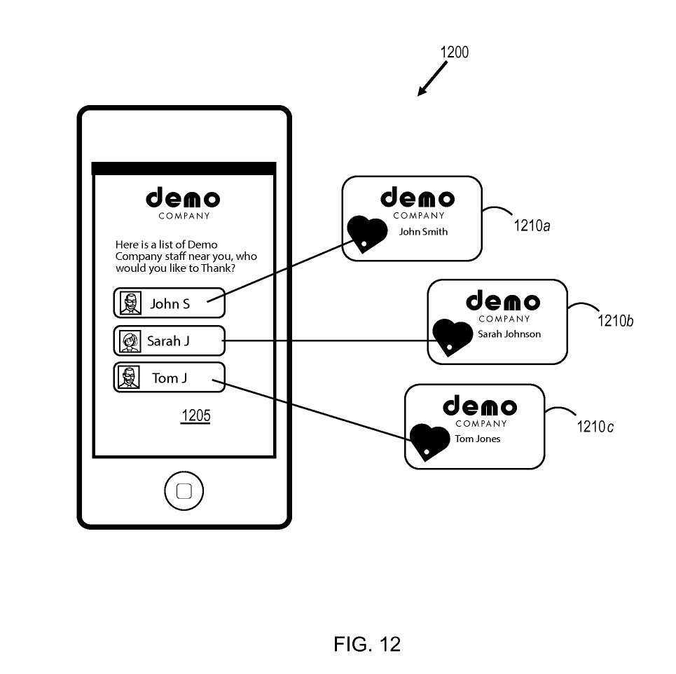

FIG. 12 is an illustration of another embodiment of the mobile computing device with the feedback application and shows the results of the scanning function of the feedback application. As shown in FIG. 12, another embodiment of the mobile computing device 1200 may comprise a feedback application 1205. FIG. 12 again shows that, after the mobile computing device 1200 scans and receives multiple response packets from nearby wireless badges, the feedback application 1205 may discover several wireless badge associated with several recipients. For example, in another embodiment, the wireless badges may be associated with the recipient John Smith. The feedback application 1205 may then perform a scan function and identify those wireless badges by showing their contacts 1210a, 1210b, 1210c within the feedback application 1205. The user may now decide to select any of the contacts 1210a, 1210b, 1210c to pair or connect with a particular wireless badge.

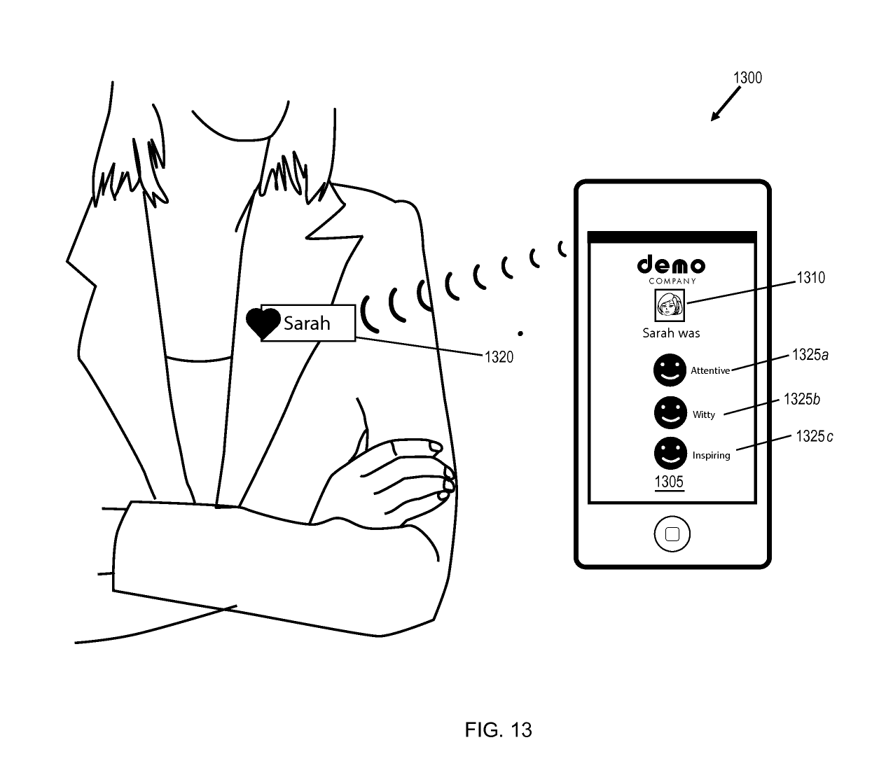

FIG. 13 is one embodiment of the mobile computing device with the feedback application and shows how a user can select an attribute for a recipient with the feedback application. As shown in FIG. 13, one embodiment of the mobile computing device 1300 may comprise a feedback application 1305. FIG. 13 shows that the computer feedback application 1305 may be connected with the wireless badge 1320 associated with the recipient Sarah. FIG. 13 also shows that the contact 1310 may be visible in the feedback application 1305 and may allow a user to assign or select one or more attributes 1325a, 1325b, 1325c to the recipient Sarah. For example, in this embodiment, the user may select, as attributes 1325a, 1325b, 1325c, to show that Sarah was attentive, witty, and inspiring.

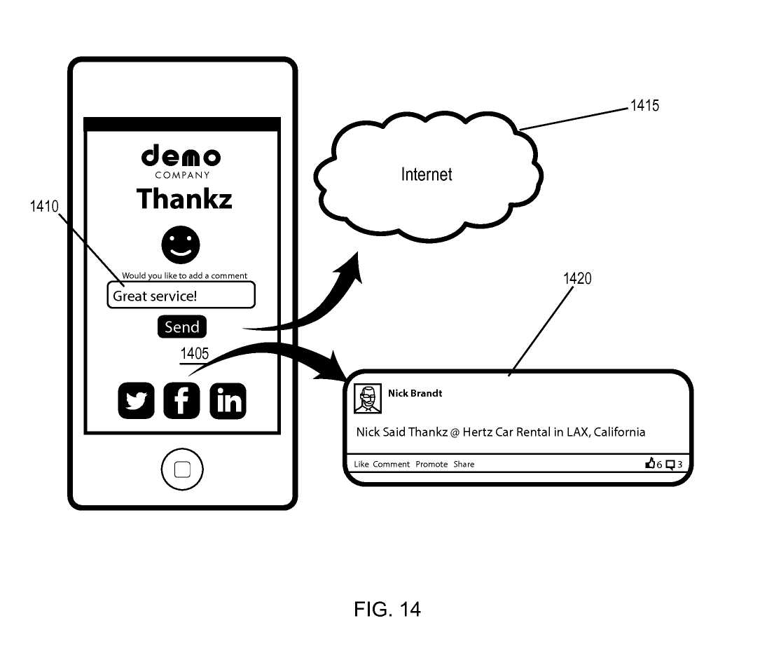

FIG. 14 is one embodiment of the mobile computing device with the feedback application and shows how a user can create and upload a user review to a server and social media. As shown in FIG. 14, one embodiment of the mobile computing device 1400 may comprise a feedback application 1405. FIG. 14 shows that the computer feedback application 1405 may comprise a user review input field 1410, which allows a user or customer to enter text to describe or comment a recipient's performance. Once inputted, the user review may be uploaded into the server 1415 for storage and evaluation. Additionally, the user review may be uploaded into a networked-based environment such as social media (e.g., Facebook®, Twitter®, Instagram®). For example, in one embodiment, the user review may be uploaded into social media 1420 such as Facebook®. It should also be understood that the feedback application 1405 may allow a user to also upload attributes assigned to a particular recipient.

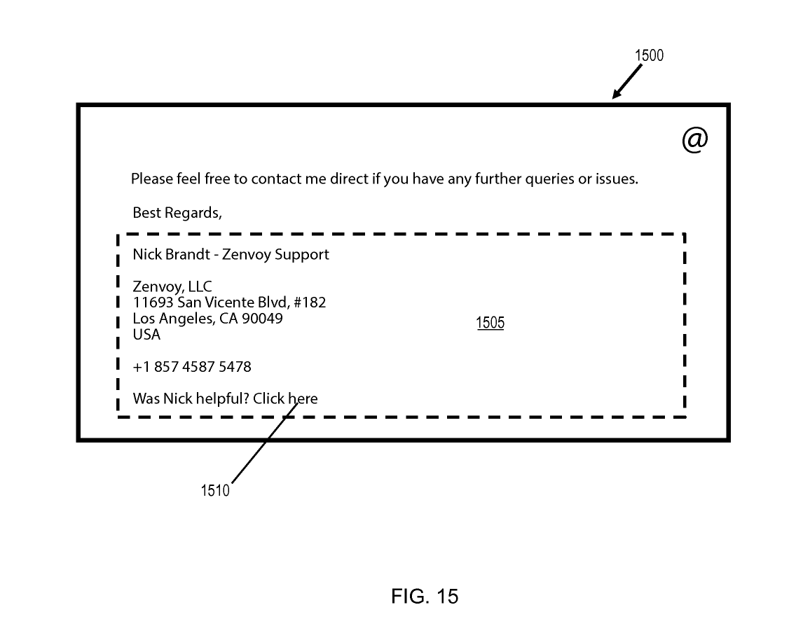

FIG. 15 is an illustration of one embodiment of an email, showing how a user may utilize the feedback application via a hyperlink in a received email. As shown in FIG. 15, one embodiment of an email may comprise a signature block 1505, and a hyperlink 1510 within the signature block 1505. FIG. 15 shows that a service provider of a company or organization can provide a user or customer with access to the feedback application without using a wireless badge.

In particular, the service provider may send an email with a signature block comprising a hyperlink 1510, which will allow the user to initiate the feedback application. Once the user or customer visits the hyperlink 1510, the feedback application may initiate. The user or customer may then provide one or more feedback reviews, which may include a user review and/or assigning attributes.

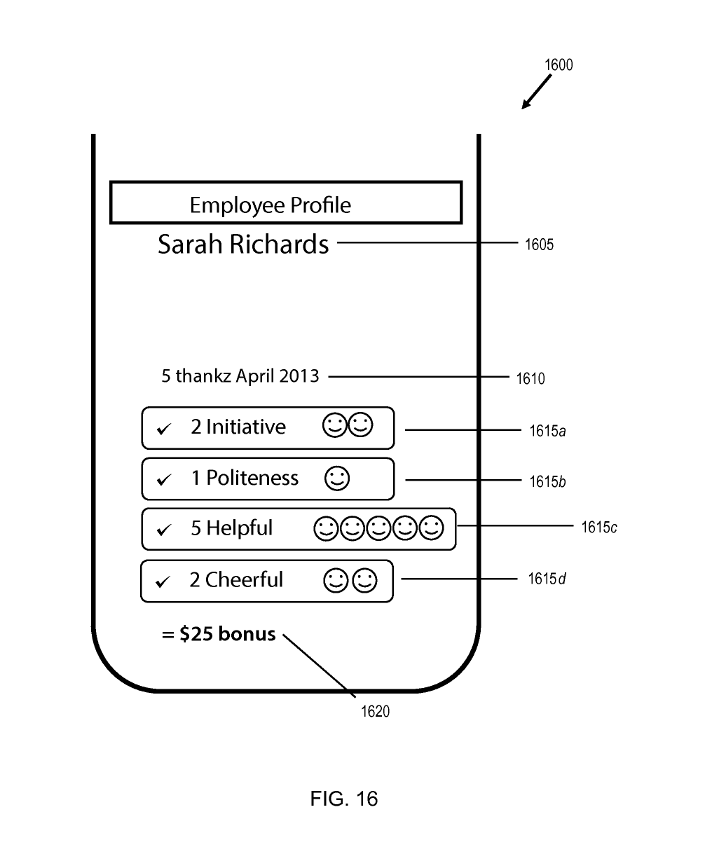

FIG. 16 is a screenshot of one embodiment of the recipient profile as shown in the feedback application. Specifically, FIG. 16 shows that one embodiment of the recipient profile may be an employee profile. As shown in FIG. 16, one embodiment of the recipient profile 1600 of the feedback application may comprise: a recipient name 1605, total feedback reviews 1610, attributes 1615a, 1615b, 1615c, 1615d, and bonus 1020. The recipient name 1605 may be the full name, user name or nickname of the recipient being reviewed. The total feedback reviews 1610 may be the amount of feedback reviews that the recipient has a received in any given time period. The attributes 1615a, 1615b, 1615c, 1615d may be the attributes assigned to a particular recipient being evaluated by users via the feedback application. The bonus 1620 may be a monetary reward earned and then given to a particular recipient due to the amount and type of feedback reviews received.

In one embodiment, as shown in FIG. 16, for example, the recipient profile 1600 may have a recipient name 1605 of Sarah Richards. As the total feedback reviews 1610, Sarah Richards may have accumulated five feedback reviews in the month of April 2013. Additionally, Sarah Richards may have been assigned: “initiative”, “politeness”, “helpful”, and “cheerful”, as the following attributes 1615a, 1615b, 1615c, 1615d, respectively. In particular, Sarah Richards may have received two attributes 1615a of “initiative”, one attribute 1615b of “politeness”, five attributes 1615c of “helpful”, and two attributes 1615d of “cheerful”. As a result, Sarah Richards may have received an added monetary bonus 1620 of $25 for her feedback reviews.

Although FIG. 16 shows that the recipient profile 1600 may include the total number of customer user reviews 1610, attributes 1615a, 1615b, 1615c, 1615d, and bonus 1020, the recipient profile may include additional features or lack any of the foregoing. For instance, the recipient profile may include user reviews, which are inputted by the customer. Alternatively, the recipient profile may lack any of the attributes or bonus.

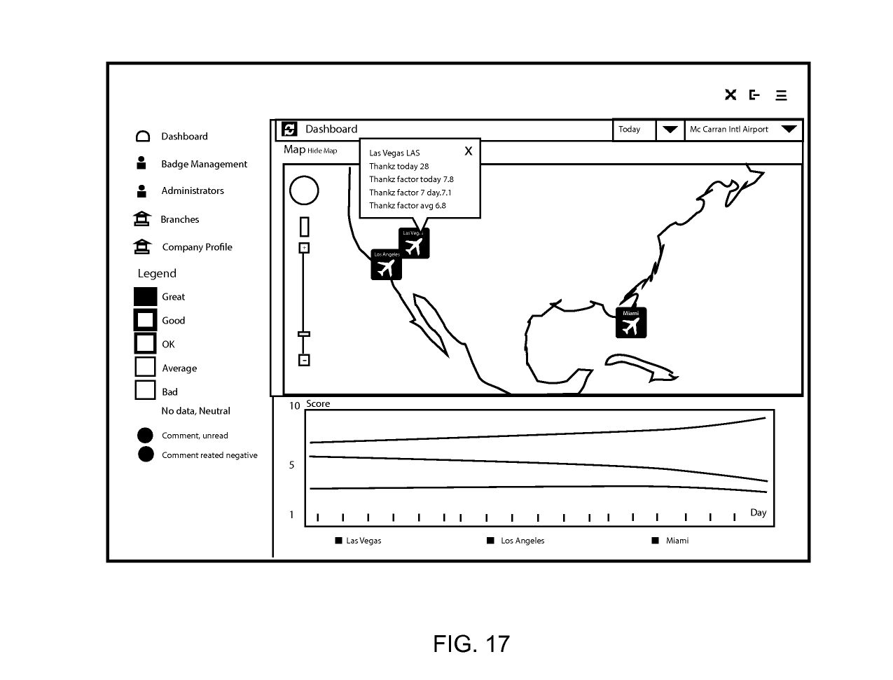

FIG. 17 is a screenshot of one embodiment of the server, and shows the data and analytics of the feedback application. As shown in FIG. 17, the server may show the data and analytics based on feedback reviews for a company in real time. The data and analytics may also show the overall performance of employees, service providers, and/or staff members for a given company and the amount and average of feedback reviews that a company has received for any particular day, month, or year. Additionally, the server may provide data as to the amount of positive feedback reviews in any location and the potential future trends for any given reviews.

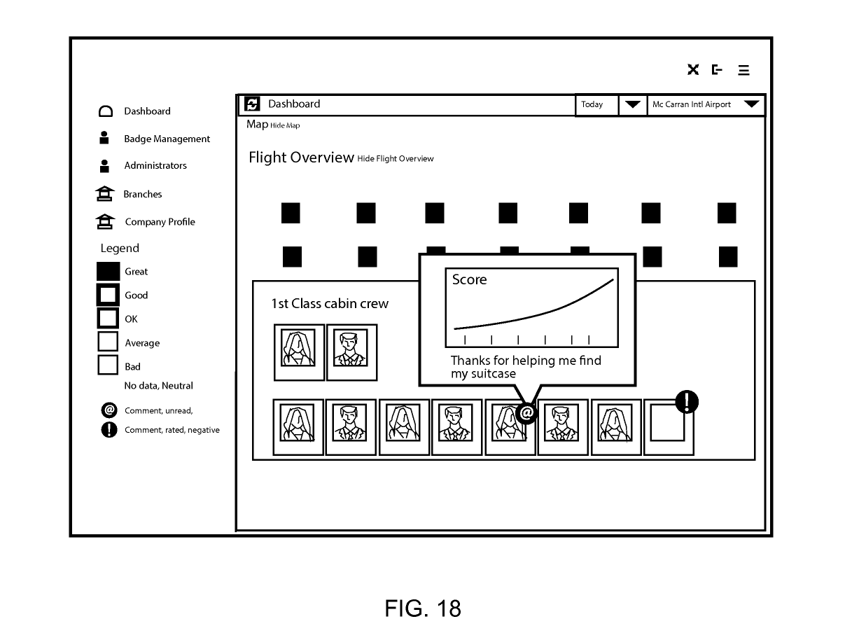

FIG. 18 is another screenshot of one embodiment of the server, and shows data and analytics of the feedback application. As shown in FIG. 18, the server may provide a dashboard, which may show the data and analytics of each employee, service provider, and/or staff member based on feedback reviews in real time. The data and analytics may also show the overall performance of each employee, service provider, and/or staff member when selecting a particular employee, service provider, coworker, and/or staff member for a given company. FIG. 18 also shows that the overall trend and amount and average of feedback reviews that a particular employee has received for any particular day, month, or year.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A system for providing and analyzing feedback and reviews, comprising:
a feedback application; and
one or more wireless badges;
wherein said feedback application is configured to run on a processor of one or more mobile computing devices, such that one or more feedback application enabled mobile computing devices are provided;
wherein said one or more wireless badges comprise a transceiver;
wherein said transceiver of said one or more wireless badges transmits one or more advertising packets;
wherein said one or more wireless badges are associated with one or more recipients;
wherein said one or more feedback application enabled mobile computing devices scans for and locates said one or more wireless badges associated with said one or more recipients located proximately near said one or more feedback application enabled mobile computing devices based on said one or more advertising packets;
wherein said one or more feedback application enabled mobile computing devices transmit one or more request packets to said transceiver of said one or more located wireless badges in response to receiving said one or more advertising packets;
wherein said one or more located wireless badges transmit one or more response packets in response to receiving said one or more request packets;
wherein said one or more feedback application enabled mobile computing devices receive one or more response packets from said one or more wireless badges;
wherein said feedback application prompts a user to input one or more feedback reviews of said one or more recipients; and
wherein said one or more feedback application enabled mobile computing devices transmit said one or more feedback reviews.

2. The system of claim 1, wherein said one or more advertising packets are associated with a user identification code.

3. The system of claim 2, wherein said one or more response packets are associated with a company identification code and a services identification code.

4. The system of claim 3, wherein said user identification code, company identification code, and services identification code of said one or more wireless badges are configurable based on varying levels of one or more administrator privileges.

5. The system of claim 1, wherein said one or more feedback application enabled mobile computing devices and said one or more wireless badges are configured to wirelessly communicate via a low power point-to-point communication protocol.

6. The system of claim 5, wherein said one or more feedback application enabled mobile computing devices and said one or more wireless badges communicate with each other via said low power point-to-point communication protocol when said one or more wireless badges and said one or more feedback application enabled mobile computing devices are within an outer range of between approximately thirty to sixty feet of each other.

7. The system of claim 1, wherein said one or more feedback reviews comprise: one or more user reviews associated with said one or more recipients.

8. The system of claim 1, wherein said one or more feedback reviews comprise one or more attributes associated with said one or more recipients.

9. The system of claim 1, wherein said one or more feedback application enabled mobile computing devices are configured to transmit said one or more feedback reviews to one or more servers.

10. The system of claim 9, wherein said one or more servers are configured to display said one or more feedback reviews in a web-based environment.

11. A computer-implemented method for providing and analyzing feedback and reviews, the steps comprising:
providing and equipping one or more wireless badges;
wherein said one or more wireless badges are associated with one or more recipients;
wherein said one or more wireless badges comprise a transceiver;
transmitting one or more advertising packets by said transceiver;
wherein one or more feedback application enabled mobile computing devices are configured to scan for and locate said one or more transmitted advertising packets of said one or more wireless badges;
wherein said one or more feedback application enabled mobile computing devices are one or more mobile computing devices comprising a feedback application running on a processor of said one or more mobile computing device;
wherein said one or more feedback application enabled mobile computing devices are configured to transmit one or more request packets in response to receiving said one or more advertising packets;
receiving by said one or more located wireless badges said one or more request packets from said one or more feedback application enabled mobile computing devices;
transmitting by said one or more wireless badges one or more response packets based on said one or more request packets;
wherein said feedback application is configured to prompt a user to input one or more feedback reviews of said one or more recipients associated with said one or more wireless badges after said one or more feedback application enabled mobile computing devices receive said one or more response packets; and
wherein said one or more feedback application enabled mobile computing devices are configured to transmit said one or more feedback reviews.

12. The computer-implemented method of claim 11, wherein said one or more advertising packets are associated with a user identification code.

13. The computer-implemented method of claim 12, wherein said one or more response packets are associated with a company identification code and a services identification code.

14. The computer-implemented method of claim 13, wherein said user identification code, company identification code, and services identification code of said wireless badge are configurable based on varying levels of one or more administrator privileges.

15. The computer-implemented method of claim 11, wherein said one or more feedback application enabled mobile computing devices and said one or more wireless badges communicate with each other via a low power point-to-point communication protocol within an outer range of between approximately thirty to sixty feet of each other.

16. A wireless badge associated with a recipient having a user identification code, comprising:
a processor;
a transceiver; and
a power source;
wherein said transceiver is electrically coupled to said processor;
wherein said power source supplies power to said processor and said transceiver;
wherein said transceiver is configured to transmit one or more advertising packets to one or more mobile computing devices via a low power point-to-point communication protocol;
wherein said transceiver is configured to receive one or more request packets from said one or more mobile computing devices;
wherein said one or more request packets are sent in response to said one or more advertising packets; and
wherein, in response to said one or more request packets, said transceiver transmits said one or more response packets to said one or more mobile computing devices.

17. The wireless badge of claim 16, wherein said one or more advertising packets are associated with a user identification code.

18. The wireless badge of claim 16, wherein said one or more response packets are associated with a company identification code and a services identification code.

19. The wireless badge of claim 16, further comprising a light source;
wherein said light source is configured to emit at least one light signal when said transceiver receives said one or more request packets from said one or more mobile computing devices.

20. The wireless badge of claim 16, further comprising a vibrating mechanism;
wherein said vibrating mechanism is configured to vibrate said wireless badge when said transceiver receives said one or more request packets from said one or more mobile computing devices.
